(19) United States
(12) Patent Application Publication
(10) Pub. No.: US 2025/0289521 A1
(43) Pub. Date: Sep. 18, 2025

(54) MOTION CONTROL METHOD AND APPARATUS OF ROBOT, ROBOT AND STORAGE MEDIUM

(71) Applicant: Beijing Youzhuju Network Technology Co., Ltd., Beijing (CN)

(72) Inventors: Jiafeng Xu, Beijing (CN); Tao Kong, Beijing (CN)

(21) Appl. No.: 19/033,444

(22) Filed: Jan. 21, 2025

(30) Foreign Application Priority Data
Mar. 18, 2024 (CN) 202410310207.2

(51) Int. Cl. B62D 57/028; B25J 5/00; B25J 9/16; B25J 13/08

(52) U.S. Cl. CPC B62D 57/028; B25J 5/007; B25J 9/1664; B25J 13/085

(57) ABSTRACT

The disclosure provides a motion control method and apparatus of a robot, a robot and a storage medium, wherein the robot is a wheel-foot composite robot, the wheel-foot composite robot comprises a robot body and four motion mechanisms arranged on the robot body, the four motion mechanisms comprise two rear rollers and two front leg mechanisms, and the method comprises: obtaining a to-be-performed task of the wheel-foot composite robot; determining a first motion task of a robot body, a second motion task of the two front leg mechanisms and a third motion task of the two rear rollers based on the to-be-performed task; and controlling the whole-body motion of the wheel-foot composite robot based on the first motion task, the second motion task and the third motion task.

### CROSS-REFERENCE

This application claims the benefit of Chinese Patent Application No. 202410310207.2 entitled “MOTION CONTROL METHOD AND APPARATUS OF ROBOT, ROBOT AND STORAGE MEDIUM” filed on Mar. 18, 2024, the entire content of which is incorporated herein by reference.

### FIELD

The embodiment of the invention relates to the technical field of robots, in particular to a motion control method and apparatus of a robot, a robot and a storage medium.

### BACKGROUND

With the development of robot technology, robots are gradually applied in various fields, for example, in industrial and agricultural production, social services, and household services, thereby assisting or even replacing humans in completing arduous and complex tasks, thus improving work efficiency and quality.

When a robot possesses multiple degrees of freedom, it is common to simultaneously plan multiple motion tasks for the robot in its operating environment, enabling the robot to execute complex whole-body tasks based on multiple motion tasks. For instance, when a robot performs a task of pushing an object while squatting, it needs to synchronously execute multiple tasks including leg lifted, torso posture control, and object pushing with its hands. However, constrained by the robot's own kinematic and dynamic limitations, multiple motion tasks may not be well accomplished simultaneously, and some motion tasks might even conflict with each other, resulting in poor whole-body motion control effects and reducing the robot's operational accuracy.

### SUMMARY

Embodiments of the present disclosure provides a motion control method and apparatus of a robot, a robot and a storage medium, which can improve the whole-body motion control effect of the robot and improve the working accuracy of the robot.

In a first aspect, an embodiment of the present disclosure provides a motion control method of a robot, where the wheel-foot composite robot comprises a robot body and four motion mechanisms arranged on the robot body, the four motion mechanisms comprise two rear rollers and two front leg mechanisms, and the method includes: obtaining a to-be-performed task of the wheel-foot composite robot, wherein a motion mode of the wheel-foot composite robot is a wheel-foot composite motion mode; determining a first motion task of the robot body, a second motion task of the two front leg mechanisms, and a third motion task of the two rear rollers based on the to-be-performed task; and controlling whole-body motion of the wheel-foot composite robot based on the first motion task, the second motion task, and the third motion task.

In a second aspect, an embodiment of the present disclosure provides a motion control apparatus of a robot, where the robot is a wheel-foot composite robot, the wheel-foot composite robot comprises a robot body and four motion mechanisms arranged on the robot body, and the four motion mechanisms comprise two rear rollers and two front leg mechanisms, and the motion control apparatus comprises: an obtaining module configured to obtain a to-be-performed task of the wheel-foot composite robot, wherein a motion mode of the wheel-foot composite robot is a wheel-foot composite motion mode; a task determining module configured to determine a first motion task of the robot body, a second motion task of the two front leg mechanisms, and a third motion task of the two rear rollers based on the to-be-performed task; and a motion control module configured to control a whole-body motion of the wheel-foot composite robot based on the first motion task, the second motion task, and the third motion task.

In a third aspect, an embodiment of the present disclosure provides a robot. The robot comprises: a processor and a memory, where the memory is configured to store a computer program, and the processor is configured to invoke and run the computer program stored in the memory to perform the motion control method of a robot according to embodiments of the first aspect.

In a fourth aspect, an embodiment of the present disclosure provides a computer-readable storage medium. The computer-readable storage medium is configured to store a computer program, where the computer program causes a computer to perform the motion control method of a robot according to embodiments of the first aspect.

In a fifth aspect, an embodiment of the present disclosure provides a computer program product including a program instruction, where when the program instruction runs on an electronic device, the electronic device performs the motion control method of a robot according to the first aspect.

### BRIEF DESCRIPTION OF DRAWINGS

In order to more clearly illustrate the technical solutions in embodiments of the present disclosure, the accompanying drawings that need to be used in the description of embodiments are briefly described below, and obviously, the drawings in the following description are merely some embodiments of the present disclosure, and for those of ordinary skill in the art, other drawings may be obtained based on these drawings without creative work.

FIG. 1 is a schematic structural diagram of a wheel-foot composite robot according to an embodiment of the present disclosure;

FIG. 2 is a flowchart of a motion control method of a robot according to an embodiment of the present disclosure;

FIG. 3 is a schematic diagram of a center point of rear rollers according to an embodiment of the present disclosure;

FIG. 4 is a flowchart of another motion control method of a robot according to an embodiment of the present disclosure;

FIG. 5 is a schematic block diagram of a motion control apparatus of a robot according to an embodiment of the present disclosure;

FIG. 6 is a schematic block diagram of a robot according to an embodiment of the present disclosure.

### DETAILED DESCRIPTION

The technical solutions in embodiments of the present disclosure are clearly and completely described below with reference to the accompanying drawings in embodiments of the present disclosure. All other embodiments obtained by those skilled in the art without creative efforts shall fall within the scope of the present disclosure.

It should be noted that the terms “first”, “second”, and the like in the specification and claims of the present disclosure and the foregoing drawings are used to distinguish similar objects, and are not necessarily used to describe a specific order or sequence. It should be understood that such used data may be interchanged where appropriate so that embodiments of the present disclosure described herein can be implemented in an order other than those illustrated or described herein. Moreover, the terms “comprising” and “having” and any variations thereof are intended to cover a non-exclusive inclusion, e.g., a process, method, system, product, or server containing a series of steps or units not necessarily limited to those steps or units expressly listed, but may include other steps or units not expressly listed or inherent to such processes, methods, products, or devices.

In embodiments of the present disclosure, words such as “example” or “for example” are used to indicate examples, illustrations, or descriptions, and any embodiment or solution described as “example” or “for example” in embodiments of the present disclosure should not be construed as being more preferred or advantageous than other embodiments or solutions. Rather, words such as “example” or “for example” are intended to present related concepts in a specific manner.

In the description of embodiments of the present disclosure, it should also be noted that, unless specified and defined otherwise, the terms “set”, “disposed”, “coupled”, and “connected” should be understood in a broad sense. For example, they can refer to fixed connection, detachable connection, or integral connection; mechanical connection or electrical connection; direct connection or indirect connection through intermediate media, or internal communication between two elements or interaction relationship between two elements. For those skilled in the art, the specific meaning of the above terms in the present disclosure can be understood in combination with the prior art according to specific conditions. In addition, in the absence of conflicts, the features in embodiments of the present disclosure may be combined with each other. Additionally, one or more of the components in the illustration may be necessary or not required, and the relative positional relationship between the various components illustrated above may be adjusted as desired.

In the description of embodiments of the present disclosure, unless otherwise specified, “a plurality of” refer to two or more, that is, at least two. “At least one” means one or more.

When a robot possesses multiple degrees of freedom, multiple motion tasks are usually planned simultaneously for the robot to enable it to execute complex whole-body tasks. However, constrained by the robot's own kinematic and dynamic limitations, multiple motion tasks may not be well accomplished simultaneously, and some motion tasks might even conflict with each other, resulting in poor whole-body motion control effects and reducing the robot's operational accuracy.

In order to solve the above technical problem, the inventive concept of the present disclosure is determining a plurality of motion tasks, such as a first motion task of the robot body, a second motion task of the two front leg mechanisms, and a third motion task of the two rear rollers based on a to-be-performed task of the wheel-foot composite robot, and then controlling the whole-body motion of the wheel-foot composite robot based on the plurality of motion tasks together. Therefore, through overall coordinated control of a plurality of motion tasks corresponding to the to-be-performed task, the overall coordination of the robot's task execution is improved, which can enhance the robot's motion control effect and increase the robot's operational accuracy.

The technical solutions of the present disclosure are described in detail below with some embodiments. Embodiments described below may be combined with each other, and may not be repeated for the same or similar concepts or processes.

First, a structure of a wheel-foot composite robot in an embodiment of the present disclosure is specifically described. As shown in FIG. 1, the wheel-foot composite robot 10 includes a robot body 11 and four motion mechanisms disposed on the robot body 11, wherein the four motion mechanisms include two rear rollers 121 and two front leg mechanisms 122.

In the present disclosure, the two front leg mechanisms 122 include a left front leg mechanism and a right front leg mechanism. Each of the front leg mechanisms 122 includes a front thigh mechanism 1221, a front shank mechanism 1222, and a roller 1223 disposed at an end of each front shank mechanism. The roller 1223 on the end of the front shank mechanism may be understood as an roller. The connecting part of the front thigh mechanism 1221 and the robot body 11 in FIG. 1 is a hip joint 13, the connecting part of the front thigh mechanism 1221 and the front shank mechanism 1222 is a knee joint 14, and the connecting part of the front shank mechanism 1222 and the roller 1223 is an ankle joint 15.

In some optional embodiments, the two rear rollers 121 are disposed at two ends of the rotatable connecting member 16, the rotatable end of the connecting member 16 is connected to one end of the rear shank mechanism 123, the other end of the rear shank mechanism 123 is connected to one end of the rear thigh mechanism 124, and the other end of the rear thigh mechanism 124 is connected to the robot body 11. The two rear rollers 121 may be understood as driving wheels.

That is, the motion mechanisms disposed on the robot body 11 in the present disclosure include a rear leg mechanism, wherein the rear leg mechanism includes a rear thigh mechanism 124, a rear shank mechanism 123, a connecting member 16, and two rear rollers 121 disposed at two ends of the connecting member 16. In the present disclosure, the connecting part of the rear thigh mechanism 124 and the robot body 11 is the hip joint 13, the connecting part of the rear thigh mechanism 124 and the rear shank mechanism 123 is the knee joint 14, the connecting part of the rear shank mechanism 124 and each rear roller 121 is the ankle joint 15. That is, the leg mechanism of the present disclosure includes a hip joint 13, a knee joint 14, and two ankle joints 15.

In addition, the hip joint 13, the knee joint 14, and the ankle joints 15 are correspondingly provided with motors, specifically, a hip joint motor, a knee joint motor and ankle joint motors, so that corresponding torques are output through the hip joint motor, the knee joint motor and/or the ankle joint motors, and the change of the hip joint 13, the knee joint 14 and/or the ankle joint 15 is driven to switch the motion mode of the wheel-foot composite robot.

The above joints may be understood as indicating that at least two components of the wheel-foot composite robot are movably connected. Moreover, each joint can move under the control of torque output by the joint motor. For example, a certain joint can rotate an angle, so that other joints and related mechanisms generate a certain amount of motion in the space, thereby realizing the motion mode change operation of the wheel-foot composite robot.

Further, in order to detect whether there is an obstacle in different motion environments and in a motion environment, at least one environment perception sensor may be disposed at the front end of the robot body 11 of the wheel-foot composite robot 10, and at least one environment perception sensor may be disposed at the rear end of the robot body 11, so that the wheel-foot composite robot may implement functions such as autonomous obstacle avoidance and mapping navigation based on the environment perception sensor.

The environment perception sensor may include, but is not limited to, a laser sensor, a vision sensor, an infrared sensor, an ultrasonic sensor, and a laser radar sensor.

As an optional implementation, a visual sensor may be disposed at a middle position of the front end of the robot body 11 shown in FIG. 1, a laser radar sensor is respectively disposed on the left and right sides of the middle of the robot body 11, a laser sensor is disposed at a middle position of the rear end of the robot body 11, and an ultrasonic sensor (not shown) is respectively disposed on the left and right sides of the middle of the robot body 11.

It should be noted that the number, the position, and the type of the environment perception sensors disposed on the robot body 11 in the present disclosure are merely illustrative, and may be flexibly adjusted based on actual application requirements, which is not limited in the present disclosure.

After the structure of the wheel-foot composite robot is described, the motion control method and apparatus of a robot, a robot and a storage medium provided in embodiments of the present disclosure are specifically described below. The robot is the wheel-foot composite robot described above.

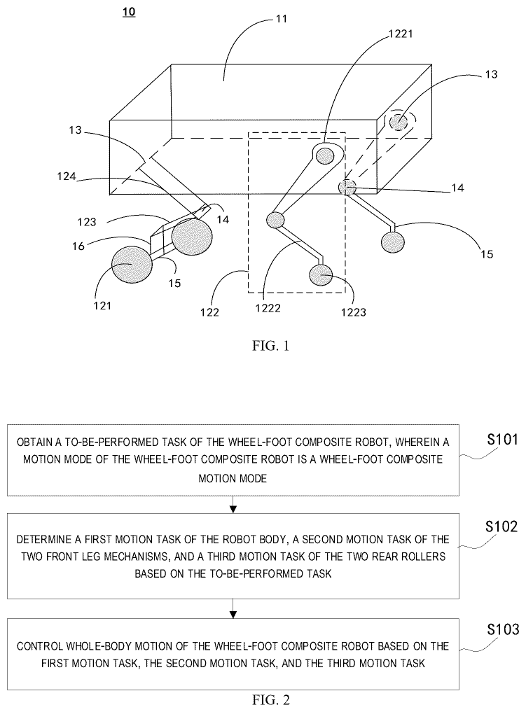

FIG. 2 is a flowchart of a motion control method of a robot according to an embodiment of the present disclosure. The motion control method of a robot provided in this embodiment of the present disclosure may be performed by a motion control apparatus of a robot, and the apparatus may be composed of hardware and/or software, and may be integrated into the wheel-foot composite robot described above.

As shown in FIG. 2, the method may include the following steps:
S101: obtaining a to-be-performed task of a wheel-foot composite robot, where a motion mode of the wheel-foot composite robot is a wheel-foot composite motion mode.

In the present disclosure, the to-be-performed task may be understood as a full-body task that needs to be performed by the wheel-foot composite robot. For example, the stolon advances or presses an elevator button or the like.

In addition, the full-body task may be any working task input by the user, or may be any working task obtained by the wheel-foot composite robot from a task allocation database, etc., and the present disclosure does not impose any limitation on obtaining manner of the to-be-performed task of the wheel-foot composite robot.

Based on the structure of the wheel-foot composite robot shown in FIG. 1, the motion modes that can be supported by the wheel-foot composite robot include a wheel-type motion mode and a wheel-foot composite motion mode. Considering that the four motion mechanisms of the wheel-foot composite robot include two rear rollers and two front leg mechanisms, the rear roller is always in a wheel-type motion mode, because the tail end of each front leg mechanism is provided with a roller, the front leg mechanism may include these two motion modes, specifically a wheel-type motion mode and a foot-type motion mode.

Correspondingly, the wheel-foot composite motion mode supported by the wheel-foot composite robot may be further subdivided into: a first wheel-foot composite motion mode obtained based on a wheel-type motion mode of the two rear rollers, a foot-type motion mode of the left front leg mechanism, and a wheel-type motion mode of the right front leg mechanism; a second wheel-foot composite motion mode obtained based on the wheel-type motion mode of the two rear rollers, the wheel-type motion mode of the left front leg mechanism, and the foot-type motion mode of the right front leg mechanism; and a third wheel-foot composite motion mode obtained based on the wheel-type motion mode of the two rear rollers and the foot-type motion modes of the two front leg mechanisms.

In embodiments of the present disclosure, the motion mode of the wheel-foot composite robot is a wheel-foot composite motion mode, and the wheel-foot composite motion mode specifically refers to a third wheel-foot composite motion mode obtained based on the wheel-type motion mode of the two rear rollers and the foot-type motion modes of the two front leg mechanisms. That is, the rear leg mechanism of the wheel-foot composite robot is in a wheel-type motion mode, and the front leg mechanism is in a foot-type motion mode.

Because the roller is arranged at the tail end of the front leg mechanism, in order to enable the front leg mechanism to be in the foot-type motion mode, the roller in the front leg mechanism can be locked through the motor corresponding to the ankle joint in the front leg mechanism, so that the roller in the front leg mechanism is switched from the wheel-type motion mode to the supporting leg in contact with the ground, so that the front leg mechanism can be ensured to be in a foot-type motion mode.

S102: determining a first motion task of the robot body, a second motion task of the two front leg mechanisms, and a third motion task of the two rear rollers based on the to-be-performed task.

The first motion task, the second motion task, and the third motion task refer to a plurality of motion tasks that need to be synchronously performed by the wheel-foot composite robot when performing the full-body task.

The above mentioned robot body may be understood as a robot torso, because the robot torso occupies a certain physical space, and may comprise multiple discrete points. Thus, in order to determine the first motion task of the robot torso, the present disclosure may reduce the difficulty of determining the first motion task by determining the first motion task of a center point of the robot torso. That is, the first motion task of the robot body in the present disclosure specifically refers to a motion task of the center point of the robot body.

In some optional embodiments, when the two front leg mechanisms are in a foot-type motion mode, the motions of the left front leg mechanism and the right front leg mechanism are similar to the walking gait of a person. That is, in each motion cycle, one front leg mechanism leaves the ground to be in a lifted state, and the other front leg mechanism contacts the ground to be in a supporting state. The front leg mechanism that leaves the ground in the lifted state may be referred to as a lifted leg mechanism, and the front leg structure that contacts the ground in the supporting state may be referred to as a supporting leg mechanism. Correspondingly, the lifted leg mechanism corresponds to a lifted foot, and the supporting leg mechanism corresponds to the supporting leg.

Considering that the supporting foot corresponding to the front leg mechanisms in the supporting state and touching the ground in the two front leg mechanisms is always in contact with the ground and do not slip, the position of the supporting foot is consistent in the world coordinate system and is known, while the touchdown point of the lifted foot, corresponding to the front leg mechanism that is off the ground and is in the lifted state, is unknown. Therefore, in order to ensure that the wheel-foot composite robot maintains the balance of the body during the motion process, it is necessary to control the position of the touchdown point of the lifted foot corresponding to the front leg mechanism that leaves the ground in the lifted state. That is, the second motion task of the two front leg mechanisms is determined in the present disclosure, specifically, the second motion task of the lifted leg mechanism in the two front leg mechanisms is determined.

In some optional embodiments, during the motion of the wheel-foot composite robot, it is required that the center point of the two rear rollers must always remain directly behind the robot's torso, so as to ensure the balance of the entire wheel-foot composite robot. Thus, in the present disclosure, determining the third motion task of the two rear rollers specifically refers to determining the third motion task of the center point of the two rear rollers.

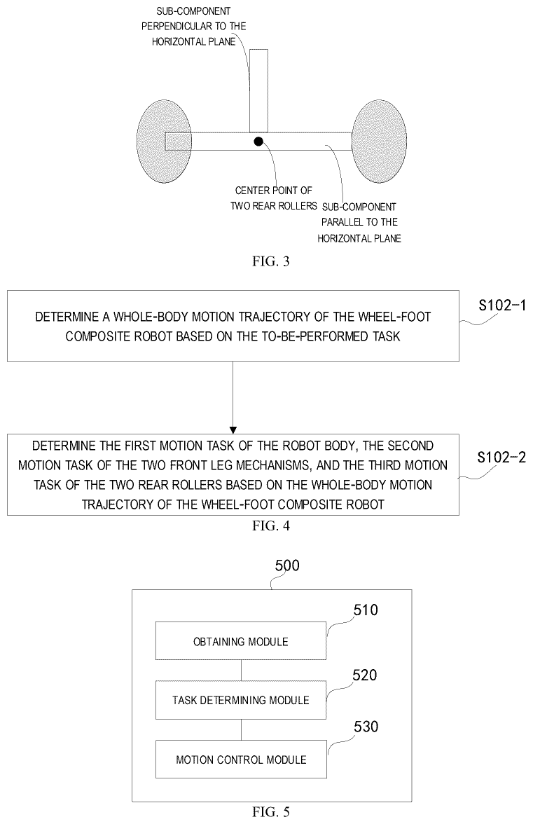

In the present disclosure, the center point of the two rear rollers may be a center point of a connecting member provided with rear rollers at both ends, as shown in FIG. 3.

In some optional embodiments, the present disclosure may use a preset trajectory planning method and the like, and plan, based on the to-be-performed task, the whole-body motion trajectory of the wheel-foot composite robot when performing the to-be-performed task.

It should be understood that the whole-body motion trajectory is an expected whole-body motion trajectory when the wheel-foot composite robot performs the to-be-performed task.

In the present disclosure, the whole-body motion trajectory includes a motion trajectory of the robot body, a motion trajectory of the lifted foot corresponding to the lifted leg mechanism, and a motion trajectory of the center point of two rear rollers; wherein the motion trajectory of the robot body includes an expect motion parameter for determining the first motion task of the robot body, such as expected position, expected posture, and expected velocity, etc. Similarly, the motion trajectory of the lifted foot corresponding to the lifted leg mechanism includes an expected motion parameter for determining the second motion task of the lifted leg mechanism in the two front leg mechanisms. In addition, the motion trajectory of the center point of the two rear rollers includes the expected motion parameter for determining the third motion task of the center point of the two rear rollers.

It should be noted that, when the motion trajectory of the center point of the two rear rollers is planned, in order to maintain the balance of the entire wheel-foot composite robot, the position of the center point of the two rear rollers needs to be controlled to always be at a fixed distance behind the robot body (that is, the robot torso). The posture of the center point of the two rear rollers is determined based on the terrain, the roll angle and the pitch angle are determined based on the terrain, the roll angle and the pitch angle are set to 0 on the flat ground, the yaw angle is kept consistent with the yaw angle of the robot body, and the planning purpose of the motion trajectory of the center point of the two rear rollers is achieved.

The position of the center point of the two rear rollers is located at a fixed distance behind the robot's torso, and this parameter may be determined according to actual debugging of the physical structure of the wheel-foot composite robot.

As an optional implementation, in the present disclosure, a motion trajectory of a center point of the two rear rollers may be planned specifically by obtaining an expected position, an expected posture, an expected velocity, and an expected angular velocity of the robot body. Next, according to a forward Kinematics (FK) algorithm, an expected position, an expected posture, an expected velocity, and an expected angular velocity of the center point of the two rear rollers in the robot body coordinate system are obtained. Then, according to the conversion relationship between the robot body coordinate system and the world coordinate system, the expected position, the expected posture, the expected velocity, and the expected angular velocity of the center point of the two rear rollers in the robot body coordinate system are converted into the expected position, the expected posture, the expected velocity and the expected angular velocity of the center point of the two rear rollers in the world coordinate system, to obtain the motion trajectory of the center point of the two rear rollers. The conversion relationship between the robot body coordinate system and the world coordinate system is known information.

It should be noted that the posture information and the angular velocity information of the center point of the two rear rollers in the present disclosure are specifically the posture information and the angular velocity information of the connecting rods where the center point of the two rear rollers is located.

Further, in the present disclosure, by obtaining the motion parameters required for determining the first motion task, the second motion task and the third motion task from the whole-body motion trajectory, the first motion task, the second motion task, and the third motion task are respectively determined based on the obtained motion parameters by using the PD control law.

The PD control law may be understood as a PD control algorithm. It should be understood that the PD control algorithm is a simplified form of the PID control algorithm, mainly adjusting the system output value and the output change rate, so that the system operates stably. Compared with a PID control algorithm, the PD control algorithm is simpler and easy to implement.

Generally, the PD control algorithm includes two parts, the first part is a proportional part, and the second part is a differential part. The proportional part obtains a first output signal by calculating the difference between the current error and the set value and multiplies the difference by a proportional system Kp. The differential part obtains a second output signal by multiplying a derivative coefficient Kd based on the change rate between the current error and the previous error. Then, the first output signal and the second output signal are added to obtain a final output signal.

The specific process of planning the whole-body motion trajectory of the wheel-foot composite robot when performing the to-be-performed task optionally comprises obtaining an end point position from the to-be-performed task by using a preset trajectory planning method and the like, taking the current position of the wheel-foot composite robot as the starting point position, and then performing the whole-body motion trajectory planning operation based on the end point position, the starting point position and the environment map of the working environment, so as to obtain the whole-body motion trajectory of the wheel-foot composite robot performing the to-be-performed task.

S103: controlling the whole-body motion of the wheel-foot composite robot based on the first motion task, the second motion task, and the third motion task.

Considering that each joint in each motion mechanism of the wheel-foot composite robot in the present disclosure is correspondingly provided with a motor, such as a hip joint provided with a hip joint motor, a knee joint provided with a knee joint motor, and an ankle joint provided with an ankle joint motor, therefore, in the present disclosure, controlling the whole-body motion of the wheel-foot composite robot based on the first motion task, the second motion task, and the third motion task may comprise determining the target torque of each joint in each motion mechanism based on the first motion task, the second motion task, and the third motion task. Then, the whole-body motion of the wheel-foot composite robot is controlled based on the target torque of each joint in each motion mechanism.

In some optional embodiments, determining the target torque of each joint in each motion mechanism based on the first motion task, the second motion task, and the third motion task may comprise editing the first motion task, the second motion task, and the third motion task into a quadratic programming form, to solve the first motion task, the second motion task, and the third motion task in the quadratic programming form by using the convex optimization algorithm, to obtain the target torque of each joint in each motion mechanism.

That is, the present disclosure converts the whole-body motion control problem of the wheel-foot composite robot into a standard convex optimization problem, and solves the standard convex optimization problem to obtain a global optimal solution, and uses the global optimal solution as the target torque of each joint in each motion mechanism.

In some optional embodiments, the above standard convex optimization problem may be as shown in the following formula (1):

$$\{ \begin{matrix}arg {min}_{x} ‖ x ‖ \\ s . t . v = J \ddot{q} + J \ddot{q} \\ C + G = [ - H , {S}^{T} , {J}^{T} ] [ \begin{matrix}\ddot{q} \\ τ \\ F\end{matrix} ] \\ x = [ \begin{matrix}\ddot{q} \\ τ \\ F\end{matrix} ] \\ DF \leq {f}^{μ} \\ lower \leq x \leq upper\end{matrix} \qquad ( 1 )$$

where x is an optimization variable and ∥x∥ is a cost function;

$$\{ \begin{matrix}s . t . v = J \ddot{q} + J \ddot{q} \\ C + G = [ - H , {S}^{T} , {J}^{T} ] [ \begin{matrix}\ddot{q} \\ τ \\ F\end{matrix} ] \\ x = [ \begin{matrix}\ddot{q} \\ τ \\ F\end{matrix} ] \\ DF \leq {f}^{μ} \\ lower \leq x \leq upper \\ \end{matrix}$$

is a constraint set, wherein \dot{v}=J\ddot{q}+\dot{J}\dot{q} is constraints for each motion task constraint;

$$C + G = [ - H , {S}^{T} , {J}^{T} ] [ \begin{matrix}\ddot{q} \\ τ \\ F\end{matrix} ]$$

is a dynamic constraint; DF≤f^{μ} is a friction cone constraint;

$$x = [ \begin{matrix}\ddot{q} \\ τ \\ F\end{matrix} ]$$

is a control variable; lower≤x≤upper is a control variable boundary constraint, wherein lower and upper are adjustable parameters, and can be dynamically set based on the hardware of the robot, wherein the upper limit value and the lower limit value of the parameter τ in x are the maximum torque of the joint motor.

The above

$$C + G = [ - H , {S}^{T} , {J}^{T} ] [ \begin{matrix}\ddot{q} \\ τ \\ F\end{matrix} ]$$

is obtained by transforming the robot dynamics equation:

$$H ( q ) \ddot{q} + C ( q , \dot{q} ) \dot{q} + G ( q ) = {S}^{T} τ + {\sum }_{i = 1}^{{N}_{C}} {J}_{i}^{T} {f}_{i} .$$

The meanings of the parameters in the above robot dynamics equation are as follows:

N is the degree of freedom of the robot, the degree of freedom in the present disclosure is an adjustable parameter, and the example may be selected as 18 dimensions, wherein 6 dimensions are for the robot torso and 12 dimensions for the joints, and the present disclosure has no limitation on the degree of freedom of the wheel-foot composite robot;
q∈R^{N} is a generalized position of a robot, and R^{N} represents an N-dimensional variable on a real set;
\dot{q}∈R^{N} is a generalized velocity of a robot;
\ddot{q}∈R^{N} is a generalized acceleration of a robot;
τ∈R^{N-6} is the joint driving torque of a robot;
fᵢ∈R³ is a ground force of the i-th contact point in the world coordinate system;
H∈R^{N×N} is a mass matrix of a robot, which can be rapidly computed using the Composite Rigid Body Algorithm (CRBA);
C∈R^{N×N} represents the centrifugal force and the Coriolis force of a robot, which is rapidly computed by using a Recursive Newton Euler Algorithm (RNEA);
G∈R^{N} is the gravity bias term of a robot, which is rapidly computed by the Recursive Newton Euler Algorithm RNEA;
S∈R^{(N-6)×N} is the selection matrix for distinguishing between the actuated joint and the unactuated joint, denoted as S=diag(0, 0, 0, 0, 0, 0, a1, a2, . . . , an), where aᵢ=0 indicates unactuated joints; the first six elements are set to 0 for unactuated joints;
Jᵢ∈R^{3×N} is the Jacobian matrix of the i-th contact point. It should be noted that because the i-th contact point only considers the Jacobian matrix of the position, and the actual Jacobian matrix is the 6×N dimension, there are only 3×N dimensions here because the position is only considered.

The above friction cone constraint DF≤f^{μ} may be obtained by the following formula:

$$\{ \begin{matrix}{f}_{x} \leq {f}_{z} {f}^{μ} \\ {f}_{y} \leq {f}_{z} {f}^{μ}\end{matrix} ,$$

wherein fₓ is the friction component of the contact point in the X-axis direction in the local coordinate system, f_{y} is the friction component of the contact point in the Y-axis direction in the local coordinate system, and f_{z} is the friction component of the contact point in the Z-axis direction in the local coordinate system, f^{μ} is the friction coefficient. It should be understood that the friction force between each contact point and the ground in the present disclosure is three dimensions, which are fₓ, f_{y} and f_{z} respectively.

In the present disclosure, the local coordinate system may be understood as a coordinate system of the local ground when the wheel-foot composite robot is in contact with the ground on any local ground. For example, assuming that the wheel-foot composite robot is in contact with the ground on a certain inclined plane, the coordinate system of the inclined plane is the local coordinate system.

Considering that when the wheel-foot composite robot moves to any local ground, the local ground may be a known ground, or the ground may also be obtained by using a perception algorithm based on environmental information collected by the environmental perception sensor, so after

$$\{ \begin{matrix}{f}_{x} \leq {f}_{z} {f}^{μ} \\ {f}_{y} \leq {f}_{z} {f}^{μ}\end{matrix}$$

is obtained in the local coordinate system,

$$\{ \begin{matrix}{f}_{x} \leq {f}_{z} {f}^{μ} \\ {f}_{y} \leq {f}_{z} {f}^{μ}\end{matrix}$$

may be transformed from the local coordinate system to the world coordinate system to obtain the friction cone matrix D in the friction cone constraint. In addition, F in the friction cone constraint may be flexibly set based on the mass of the wheel-foot composite robot, which is not limited in the present disclosure.

In the present disclosure, in each of the above motion task constraints \dot{v}=J\ddot{q}+\dot{J}\dot{q}, J is a Jacobian matrix representing a contact point, and q represents a generalized position, [⋅] represents the first derivative, that is, a velocity \dot{q} may be obtained based on the generalized position q, [⋅] represents the second derivative, that is, an acceleration \ddot{q} may be obtained based on the generalized position 1. A relationship between a control variable that needs to be optimized and a motion task corresponding to the wheel-foot compound robot may be established through Jacobian, so that the solution of the optimization problem may help the wheel-foot composite robot complete a corresponding full-body tasks.

Considering that the control variable in the present disclosure is in the joint space, while the first motion task, the second motion task, and the third motion task corresponding to the wheel-foot composite robot are all within a three-dimensional space (that is, a Cartesian space), in order to obtain the constraint \dot{v}=J\ddot{q}+\dot{J}\dot{q} of each motion task, the present disclosure may establish the relationship between the joint space and the three-dimensional space (that is, the Cartesian space) by using the following formula (2):

$$J \dot{q} = V \qquad ( 2 )$$

Then, derivation is performed on the formula (2), and the motion task constraint \dot{v}=J\ddot{q}+\dot{J}\dot{q} corresponding to each motion task may be obtained. In the motion task constraint \dot{v}=J\ddot{q}+\dot{J}\dot{q}, \dot{v} is the acceleration of the center point of the robot body corresponding to the first motion task in the Cartesian coordinate system, the acceleration of the lifted foot of the lifted leg mechanism corresponding to the second motion task in the Cartesian coordinate system, and the acceleration of the center point of the two rear rollers in the Cartesian coordinate system corresponding to the third motion task, J is the Jacobian matrix of each of the motion tasks, and \ddot{q} is the corresponding joint acceleration for realizing each of the motion tasks and \dot{q} is the current joint velocity. The constraint of \ddot{q} may be set based on the maximum acceleration of the robot, which is not specifically limited in the present disclosure.

In some optional embodiments, before determining the target torque of each joint in each motion mechanism in the wheel-foot composite robot based on the foregoing formula (1), optionally, the present disclosure may first compute a Jacobian matrix of the first motion task, a Jacobian matrix of the second motion task, and a Jacobian matrix of the third motion task corresponding to each timestamp. Then, the Jacobian matrix of the first motion task, the Jacobian matrix of the second motion task, and the Jacobian matrix of the third motion task corresponding to the same timestamp are brought into the foregoing motion task constraints \dot{v}=J\ddot{q}+\dot{J}\dot{q} to obtain the corresponding three motion task constraints at the same timestamp.

$$\{ \begin{matrix}{J}_{1} \ddot{q} + {\dot{J}}_{1} \dot{q} = {\dot{v}}_{1} \\ {J}_{2} \ddot{q} + {\dot{J}}_{2} \dot{q} = {\dot{v}}_{2} \\ {J}_{3} \ddot{q} + {\dot{J}}_{3} \dot{q} = {\dot{v}}_{3}\end{matrix} \qquad ( 3 )$$

wherein J₁\ddot{q}+\dot{J}₁\dot{q}=\dot{v}₁ is the first motion task constraint, J₂\ddot{q}+\dot{J}₂\dot{q}=\dot{v}₂ is a second motion task constraint, and J₃\ddot{q}+\dot{J}₃\dot{q}=\dot{v}₃ is a third motion task constraint.

In the present disclosure, the Jacobian matrix of the first motion task, the Jacobian matrix of the second motion task, and the Jacobian matrix of the third motion task corresponding to each timestamp may be computed, and reference may be made to the prior art, and details are not described herein again.

Then, the three motion task constraints corresponding to different timestamps described in the foregoing formula (3) are brought into the foregoing formula (1) to solve the target torque of each joint of the wheel-foot composite robot at different timestamps.

In the present disclosure, the joints of the wheel-foot composite robot may include: a left hip joint, a left knee joint, and a left ankle joint in a left front leg mechanism, a right hip joint, a right knee joint, and a right ankle joint in a right front leg mechanism, and a back leg hip joint, a back leg knee joint, and a back leg ankle joint in a back leg mechanism, which may be specifically referred to FIG. 1.

It should be noted that the Jacobian matrix of the first motion task is specifically the Jacobian matrix of the center point of the robot body, the Jacobian matrix of the second motion task is specifically the Jacobian matrix corresponding to the lifted foot of the lifted leg mechanism in the front leg mechanism, and the Jacobian matrix of the third motion task is specifically the Jacobian matrix of the center point of the two rear rollers.

In addition, the Jacobian matrices of the first motion task and the third motion task are optional matrices of 6*18 dimensions. Wherein, 6 is 6 degrees of freedom, specifically 3 rotational dimensions and 3 translational dimensions along the X-axis, the Y-axis, and the Z-axis. 18 is the freedom degree of the wheel-foot composite robot. Because the second task is the foot contact point, only the 3-dimensional position is considered, that is, the Jacobian matrix of the second motion task is a 3*18-dimensional matrix, where 3 is 3 degrees of freedom, specifically 3 translational dimensions along the X-axis, the Y-axis, and the Z-axis.

In addition, each motion task may be three-dimensional or six-dimensional. The motion task includes a first motion task, a second motion task, and a third motion task.

The above three dimensions may be understood as three degrees of freedom, specifically three rotation dimensions or 3 translation dimensions along the X axis, the Y axis, and the Z axis, and the six dimensions may be understood as six degrees of freedom, specifically 3 rotation dimensions and 3 translation dimensions along the X axis, the Y axis, and the Z axis.

After the target torque of each joint in each motion mechanism is determined, in the present disclosure, the whole-body motion of the wheel-foot composite robot can be controlled based on the target torque of each joint in each motion mechanism.

Because each joint of the wheel-foot composite robot corresponds to one motor, after the target torque of each joint in each motion mechanism in the wheel-foot composite robot is obtained, in the present disclosure each motor can be controlled to output a target torque to the corresponding joint based on the target torque of each joint, so as to drive each joint to rotate by a corresponding angle, so that other joints and related mechanisms associated with each joint generate a certain amount of motion in the space, thereby realizing whole-body motion control of the wheel-foot composite robot.

According to the technical scheme disclosed by embodiments of the present disclosure, by obtaining the to-be-performed task of the wheel-foot composite robot, the first motion task of the robot body, the second motion task of the two front leg mechanisms and the third motion task of the two rear rollers are determined based on the to-be-performed task, and then the whole-body motion of the wheel-foot composite robot is controlled based on the first motion task, the second motion task and the third motion task. Therefore, by performing overall coordination control on the plurality of motion tasks corresponding to the to-be-performed task, the overall coordination of the robot's task execution is improved, so that the motion control effect of the robot can be improved, and the operational accuracy of the robot is improved.

Based on the foregoing embodiment, the following provides further explanation of determining the first motion task of the robot body, the second motion task of the two front leg mechanisms, and the third motion task of the two rear rollers based on the to-be-performed task in the foregoing embodiment with reference to FIG. 4. As shown in FIG. 4, the above step S102 may include the following steps:
S102-1: determining a whole-body motion trajectory of the wheel-foot composite robot based on the to-be-performed task.

S102-2: determining a first motion task of the robot body, a second motion task of the two front leg mechanisms, and a third motion task of the two rear rollers based on the whole-body motion trajectory of the wheel-foot composite robot.

The second motion task of the two front leg mechanisms is specifically a motion task of the lifted leg mechanism in the two front leg mechanisms. The third motion task of the two rear rollers is specifically the motion task of the center point of the two rear rollers.

Optionally, the present disclosure may plan a whole-body motion trajectory of the wheel-foot composite robot based on the to-be-performed task by using a preset trajectory planning manner. The whole-body motion trajectory comprises a motion trajectory of a robot body, a motion trajectory of a lifted foot corresponding to the lifted leg mechanism and a motion trajectory of the center point of the two rear rollers; wherein the motion trajectory of the robot body comprises at least one expected position, at least one expected posture, at least one expected velocity and at least one expected angular velocity; the motion trajectory of the lifted foot corresponding to the lifted leg mechanism comprises at least one expected position and at least one expected velocity; the motion trajectory of the center point of the two rear rollers comprises at least one expected position, at least one expected posture, at least one expected velocity and at least one expected angular velocity.

Therefore, in the present disclosure, when the first motion task is determined based on the whole-body motion trajectory of the wheel-foot composite robot, the expected position, the expected velocity, the expected posture and the expected angular velocity of the robot body at different timestamps can be obtained from the motion trajectory of the robot body. In addition, the actual position, the actual posture, the actual velocity and the actual angular velocity of the robot body at different timestamps are obtained through the state detection module or the state perception module. The state detection module or the state perception module may determine the actual state information of the robot body according to a preset cycle, and the preset cycle in the present disclosure may be comprehensively determined based on the state detection requirement, the hardware computing power, and the algorithm complexity, which is not limited herein.

Then, the PD control law is used to determine the position motion sub-task of the robot body corresponding to each timestamp based on the expected position, the actual position, the expected velocity and the actual velocity at the same timestamp. Meanwhile, the posture motion sub-task of the robot body corresponding to each timestamp is determined by using the PD control law based on the expected posture, the actual posture, the expected angular velocity and the actual angular velocity at the same timestamp. Then, a first motion task of the robot body corresponding to each timestamp is obtained based on the posture motion sub-task and the position motion sub-task of the robot body corresponding to each timestamp.

It should be understood that the first motion task of the robot body includes: a position motion sub-task and a posture motion sub-task of the robot body.

Optionally, the position motion sub-task of the robot body may be determined by using the following formula (11):

$${\dot{v}}_{{t}_{body}} = {kp}_{body 1} ( {p}_{{t}_{des}} - {p}_{{t}_{act}} ) + {kd}_{body 1} ( {v}_{{t}_{des}} - {v}_{{t}_{act}} ) \qquad ( 4 )$$

wherein \dot{v}_{body} is the robot body position motion sub-task corresponding to the t-th timestamp, and \dot{v}_{body}∈R³, wherein \dot{v}_{body} corresponds to 4 to 6 dimensions of \ddot{q} in the dynamic equation, t is the timestamp, pₜ_{_{des}} is the expected position of the robot body corresponding to the t-th timestamp; pₜ_{_{act}} is the actual position of the robot body corresponding to the t-th timestamp; vₜ_{_{des}} is the expected velocity of the robot body corresponding to the t-th timestamp; vₜ_{_{act}} is the actual velocity of the robot body corresponding to the t-th timestamp; kp_{body1} is the position control gain of the robot body, kd_{body1} is the velocity control gain of the robot body, and kp_{body1} and kd_{body1} are respectively adjustable parameters.

In addition, determining the posture motion sub-task of the robot body corresponding to each timestamp may be implemented by the following formula (5):

$${\dot{ω}}_{{t}_{body}} = {kp}_{body 2} ( {rpy}_{{t}_{des}} - {rpy}_{{t}_{act}} ) + {kd}_{body 2} ( {ω}_{{t}_{des}} - {ω}_{{t}_{act}} ) \qquad ( 5 )$$

wherein \dot{ω}ₜ_{_{body}} is the robot body posture motion sub-task corresponding to the t-th timestamp, and \dot{ω}_{body}∈R³, wherein \dot{ω}_{body} corresponds to 1 to 3 dimensions of \ddot{q} in the dynamic equation, rpyₜ_{_{des}} is the expected posture of the robot body corresponding to the t-th timestamp, wherein the rpy is specifically an abbreviation of the roll-pitch-yaw; rpyₜ_{_{act}} is the actual posture of the robot body corresponding to the t-th timestamp, ω_{des} is the expected angular velocity of the robot body corresponding to the t-th timestamp; ω_{act} is the actual angular velocity of the robot body corresponding to the t-th timestamp; kp_{body2} is the posture control gain of the robot body, kd_{body2} is an angle velocity control gain of the robot body, and kp_{body2} and kd_{body2} are adjustable parameters.

Considering that posture can be represented in multiple ways including quaternion, rotation matrix, and rpy posture angle, as an optional implementation, the present disclosure uses the rpy posture angle to represent the posture. That is, the posture motion sub-task of the robot body is determined based on the posture of the robot body represented by the rpy posture angle. Of course, in the present disclosure, the posture motion sub-task of the robot body may also be determined based on the posture of the robot body represented by the quaternion, or based on the posture of the robot body represented by the rotation matrix, which is not limited herein.

In some optional embodiments, in the present disclosure, when the second motion task is determined based on the whole-body motion trajectory of the wheel-foot composite robot, expected positions and expected velocities of the lifted foot at different timestamps may be obtained from the motion trajectory of the lifted foot corresponding to the lifted leg mechanism. Then, the actual positions and the actual velocities of the robot body at different timestamps are obtained through the state detection module or the state perception module. Then, according to the FK algorithm, the actual positions of the lifted foot relative to the robot body under different timestamps are computed based on the actual positions of the robot body at different timestamps, and the actual velocities of the lifted foot relative to the robot body under different timestamps are computed based on the actual velocities of the robot body at different timestamps. Then, according to the conversion relationship between the robot body coordinate system and the world coordinate system, the actual positions and the actual velocities of the lifted foot relative to the robot body under different timestamps are converted into the actual positions and the actual velocities of the lifted foot in the world coordinate system under different timestamps. Then, the second motion task of the lifted leg mechanism corresponding to each timestamp is determined by using the PD control law based on the expected position, the actual position, the expected velocity and the actual velocity at the same timestamp.

Optionally, the second motion task of the lifted leg mechanism corresponding to each timestamp may be determined by using the following formula (6):

$${\dot{v}}_{{t}_{foot}} = kp ( {p}_{{t}_{des}} - {p}_{{t}_{act}} ) + kd ( {v}_{{t}_{des}} - {v}_{{t}_{act}} ) \qquad ( 6 )$$

wherein \dot{v}ₜ_{_{foot}} is the second motion task of the lifted leg mechanism corresponding to the t-th timestamp; pₜ_{_{des}} is the expected position of the lifted foot corresponding to the t-th timestamp; pₜ_{_{act}} is the actual position of the lifted foot corresponding to the t-th timestamp; vₜ_{_{des}} is the expected velocity of the lifted foot corresponding to the t-th timestamp; vₜ_{_{act}} is the actual velocity of the lifted foot corresponding to the t-th timestamp; kp is the position control gain of the lifted foot, kd is the velocity control gain of the lifted foot, and kp and kd are adjustable parameters respectively.

It should be noted that, the expected position of the lifted foot of the lifted leg mechanism corresponding to each timestamp may also be determined by using a motion planner, such as a herististic planner, based on the expected velocity of the robot body, the actual velocity of the robot body, and the remaining swing time of the lifted leg mechanism when the lifted leg mechanism is in the swing state. Specifically, a landing point position of the lifted foot at each foot landing moment may be first determined, and then each foot landing position is interpolated to obtain the expected position of the lifted foot of the lifted leg mechanism corresponding to each timestamp.

The landing point position of the lifted foot at each foot landing moment may be determined by the following formula (7):

$${W}_{foot} = \frac{\dot{x} {T}_{s}}{2} + {k}_{\dot{x}} ( \dot{x} - {\dot{x}}_{d} ) \qquad ( 7 )$$

wherein, W_{foot} is the landing point position of the lifted foot at the foot landing moment, \dot{X} is the actual velocity of the robot body, Tₛ is the remaining swing time when the lifted leg mechanism is in the lifted state, k_{\dot{x}} is the control gain of the foot landing position of the lifted foot with respect to the actual velocity error of the robot body, and \dot{x}_{d} is the expected velocity of the robot body.

In some optional embodiments, in the present disclosure, when the third motion task is determined based on the whole-body motion trajectory of the wheel-foot composite robot, the expected positions, the expected velocities, the expected postures, and the expected angular velocities of the center point of the two rear rollers at different timestamps may be obtained from the motion trajectory of the center point of the two rear rollers. In addition, the actual positions, the actual postures, the actual velocities and the actual angular velocities of the robot body at different timestamps are obtained through the state detection module or the state perception module. Further, using the FK algorithm the actual positions of the center point of the two rear rollers relative to the robot body at different timestamps are computed based on the actual positions of the robot body at different timestamps, the actual postures of the center point of the two rear rollers relative to the robot body at different timestamps are computed based on the actual postures of the robot body at different timestamps, the actual velocities of the center point of the two rear rollers relative to the robot body at different timestamps are computed based on the actual velocities of the robot body at different timestamps, and the actual angular velocities of the center point of the two rear rollers relative to the robot body at different timestamps are computed based on the actual angular velocities of the robot body at different timestamps. Then, according to the conversion relationship between the robot body coordinate system and the world coordinate system, the actual positions, the actual postures, the actual velocities, and the actual angular velocities of the center point of the two rear rollers at different timestamps are converted into the actual positions, the actual postures, the actual velocities and the actual angular velocities of the center point of the two rear rollers in the world coordinate system at different timestamps. Then, the PD control law is used to determine the position motion sub-task of the center point of the two rear rollers corresponding to each timestamp based on the expected position, the actual position, the expected velocity and the actual velocity of the same timestamp. Meanwhile, the PD control law is used to determine the posture motion sub-task of the center point of the two rear rollers corresponding to each timestamp based on the expected posture, the actual posture, the expected angular velocity and the actual angular velocity at the same timestamp. Then, based on the posture motion sub-task and the position motion sub-task of the center point of the two rear rollers corresponding to each timestamp, the third motion task of the center point of the two rear rollers corresponding to each timestamp is obtained.

It should be understood that the third motion task of the center point of the two rear rollers includes: a position motion sub-task and a posture motion sub-task of the center point of the two rear rollers.

Optionally, the position motion sub-task of the center point of the two rear rollers corresponding to each timestamp may be determined by using the following formula (8):

$${\dot{v}}_{{t}_{center}} = {kp}_{center 1} ( {p}_{{t}_{des}} - {p}_{{t}_{act}} ) + {kd}_{center 1} ( {v}_{{t}_{des}} - {v}_{{t}_{ct}} ) \qquad ( 8 )$$

wherein \dot{v}ₜ_{_{center}} is the position motion sub-task of the center point of the two rear rollers corresponding to the t-th timestamp; pₜ_{_{des}} is the expected position of the center point of the two rear rollers corresponding to the t-th timestamp, pₜ_{_{act}} is the actual position of the center point of the two rear rollers corresponding to the t-th timestamp; vₜ_{_{des}} is the expected velocity of the center point of the two rear rollers corresponding to the t-th timestamp; vₜ_{_{act}} is the actual velocity of the center point of the two rear rollers corresponding to the t-th timestamp; kp_{center1} is the position control gain for the center point of the two rear rollers, and kd_{center1} is the velocity control gain for the center point of the two rear rollers, and kp_{center1} and kd_{center1} are respectively adjustable parameters.

In addition, the posture motion sub-task of the center point of the two rear rollers corresponding to each timestamp may be determined by the following formula (9):

$${\dot{ω}}_{{t}_{center}} = {kp}_{center 2} ( {rpy}_{{t}_{des}} - {rpy}_{{t}_{act}} ) + {kd}_{center 2} ( {ω}_{{t}_{des}} - {ω}_{{t}_{act}} ) \qquad ( 9 )$$

wherein \dot{ω}ₜ_{_{center}} is the posture motion sub-task of the center point of the two rear rollers corresponding to the t-th timestamp; rpyₜ_{_{des}} is the expected posture of the center point of the two rear rollers corresponding to the t-th timestamp, rpyₜ_{_{act}} is the actual posture of the center point of the two rear rollers corresponding to the t-th timestamp; ω_{des} is the expected angular velocity of the center point of the two rear rollers corresponding to the t-th timestamp, ω_{act} is the actual angular velocity of the center point of the two rear rollers corresponding to the t-th timestamp; kp_{center2} is the posture control gain of the center point of the two rear rollers, kd_{center2} is a velocity control gain of the center point of the two rear rollers, and the kp_{center2} and kd_{center2} are respectively adjustable parameters.

Considering that posture can be represented in multiple ways including quaternion, rotation matrix, and rpy posture angle, as an optional implementation, the present disclosure uses the rpy posture angle to represent the posture. That is, the posture motion sub-task of the center point of the two rear rollers is determined based on the posture of the center point of the two rear rollers represented by the rpy posture angle. Of course, in the present disclosure, the posture motion sub-task of the center point of the two rear rollers may also be determined based on the posture of the center point of the two rear rollers represented by the quaternion, or based on the posture of the center point of the two rear rollers represented by the rotation matrix, which is not limited herein.

According to the technical scheme disclosed by the embodiment of the invention, by obtaining the to-be-performed task of the wheel-foot composite robot, the first motion task of the robot body, the second motion task of the two front leg mechanisms and the third motion task of the two rear rollers are determined based on the to-be-performed task, and then the whole-body motion of the wheel-foot composite robot is controlled based on the first motion task, the second motion task and the third motion task. Therefore, by performing overall coordination control on the plurality of motion tasks corresponding to the to-be-performed task, the overall coordination of the robot's task execution is improved, so that the motion control effect of the robot can be improved, and the operational accuracy of the robot is improved.

A motion control apparatus of a robot according to an embodiment of the present disclosure is described below with reference to FIG. 5. In the present disclosure, the robot is the wheel-foot composite robot shown in FIG. 1, the wheel-foot composite robot includes a robot body and four motion mechanisms arranged on the robot body, and the four motion mechanisms include two rear rollers and two front leg mechanisms. As shown in FIG. 5, the motion control apparatus 500 of a robot includes an obtaining module 510, a task determining module 520, and a motion control module 530.

The obtaining module 510 is configured to obtain a to-be-performed task of the wheel-foot composite robot, where a motion mode of the wheel-foot composite robot is a wheel-foot composite motion mode.

The task determining module 520 is configured to determine a first motion task of the robot body, a second motion task of the two front leg mechanisms, and a third motion task of the two rear rollers based on the to-be-performed task.

The motion control module 530 is configured to control the whole-body motion of the wheel-foot composite robot based on the first motion task, the second motion task, and the third motion task.

In an optional implementation of embodiments of the present disclosure, the motion control module 530 includes: a torque determining unit configured to determine a target torque of each joint in each motion mechanism based on the first motion task, the second motion task, and the third motion task; a motion control unit configured to control the whole-body motion of the wheel-foot composite robot based on the target torque of each joint in each motion mechanism.

In an optional implementation of embodiments of the present disclosure, the torque determining unit is specifically configured to edit the first motion task, the second motion task, and the third motion task into a quadratic programming form, and solve by using a convex optimization algorithm to obtain the target torque of each joint in each motion mechanism.

In an optional implementation of embodiments of the present disclosure, each joint in each motion mechanism corresponds to one motor, and the motion control unit is specifically configured to control each motor to output the target torque to a corresponding joint based on the target torque of each joint, so as to implement whole-body motion control of the wheel-foot composite robot.

In an optional implementation of embodiments of the present disclosure, the task determining module 520 includes: a trajectory determining unit configured to determine a whole-body motion trajectory of the wheel-foot composite robot based on the to-be-performed task; a task determining unit configured to determine the first motion task of the robot body, the second motion task of the two front leg mechanisms, and the third motion task of the two rear rollers based on the whole-body motion trajectory.

In an optional implementation of embodiments of the present disclosure, a first motion task of the robot body is a motion task of a center point of the robot body; the second motion task is a motion task of a lifted leg mechanism in the two front leg mechanisms; and the third motion task is a motion task of a center point of two rear rollers.

In an optional implementation of embodiments of the present disclosure, the whole-body motion trajectory includes: a motion trajectory of the robot body, a motion trajectory of a lifted foot corresponding to the lifted leg mechanism, and a motion trajectory of a center point of the two rear rollers; the robot body motion trajectory includes at least one expected position, at least one expected posture, at least one expected velocity, and at least one expected angular velocity; the motion trajectory of the lifted foot corresponding to the lifted leg mechanism includes at least one expected position and at least one expected velocity.

The motion trajectory of the center point of the two rear rollers includes at least one expected position, at least one expected posture, at least one expected velocity, and at least one expected angular velocity.

In an optional implementation of embodiments of the present disclosure, the task determining unit is specifically configured to: determine an actual position corresponding to each expected position, an actual velocity corresponding to each expected velocity, an actual posture corresponding to each expected posture, and an actual angular velocity corresponding to each expected angular velocity of the robot body; determine a position motion sub-task of the robot body corresponding to each timestamp based on the expected position, the actual position, the expected velocity, and the actual velocity at a same timestamp; and determine a posture motion sub-task of the robot body corresponding to each timestamp based on the expected posture, the actual posture, the expected angular velocity and the actual angular velocity at the same timestamp; obtain the first motion task of the robot body corresponding to each timestamp based on the posture motion sub-task and the position motion sub-task of the robot body corresponding to each timestamp.

In an optional implementation of embodiments of the present disclosure, the task determining unit is specifically configured to: determine an actual position corresponding to the each expected position, and an actual velocity corresponding to the each expected velocity of the lifted foot; and determine the second motion task of the lifted leg mechanism in the two front leg mechanisms corresponding to each timestamp based on the expected position, the actual position, the expected velocity and the actual velocity at a same timestamp.

In an optional implementation of embodiments of the present disclosure, the task determining unit is specifically configured to: determine an actual position corresponding to the each expected position, an actual velocity corresponding to the each expected velocity, an actual posture corresponding to the each expected posture, and an actual angular velocity corresponding to the each expected angular velocity of the center point of the two rear rollers; determine, based on the expected position, the actual position, the expected velocity, and the actual velocity at a same timestamp, a position motion sub-task corresponding to each timestamp corresponding to two rear roller center points; determine, according to the expected posture, the actual posture, the expected angular velocity and the actual angular velocity of the same timestamp, a posture motion sub-task of the center point of the two rear rollers corresponding to each timestamp; obtain the third motion task of the center point of the two rear rollers corresponding to each timestamp based on the posture motion sub-task and the position motion sub-task of the center point of the two rear rollers corresponding to each timestamp.

In an optional implementation of embodiments of the present disclosure, the wheel-foot composite motion mode is obtained based on a wheel-type motion mode of the two rear rollers and a foot-type motion mode of the two front leg mechanisms.

It should be understood that the apparatus embodiments and the foregoing method embodiments may correspond to each other, and similar descriptions may refer to the method embodiments. To avoid repetition, details are not described herein again. Specifically, the apparatus 500 shown in FIG. 5 may perform the method embodiment corresponding to FIG. 2, and the foregoing and other operations and/or functions of each module in the apparatus 500 are respectively used to implement corresponding procedures in the methods in FIG. 2.

The apparatus 500 in this embodiment of the present disclosure is described above with reference to an angle of a functional module with reference to the accompanying drawings. It should be understood that the functional module may be implemented in hardware, or may be implemented by using an instruction in a form of software, or may be implemented by combining hardware and software modules. Specifically, steps in the method embodiment of the first aspect in this embodiment of the present disclosure may be completed by using an integrated logic circuit of hardware in a processor and/or an instruction in a form of software, and the steps in the method according to the first aspect disclosed in embodiments of the present disclosure may be directly reflected as execution of a hardware decoding processor, or performed by combining hardware and software modules in a decoding processor. Optionally, the software module may be located in a mature storage medium in the art such as a random access memory, a flash memory, a read-only memory, a programmable read-only memory, an electrically erasable programmable memory, a register, and the like. The storage medium is located in the memory, the processor reads information in the memory, and completes the steps in the foregoing method embodiment of the first aspect in combination with hardware of the storage medium.

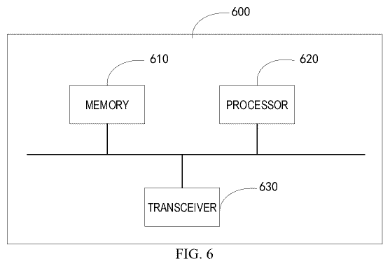

FIG. 6 is a schematic block diagram of a robot according to an embodiment of the present disclosure. The robot in the present disclosure is the wheel-foot composite robot described in FIG. 1. As shown in FIG. 6, the robot 600 may include a memory 610 and a processor 620.

The memory 610 is configured to store a computer program, and transmit the program code to the processor 620. In other words, the processor 620 may invoke and run the computer program from the memory 610 to implement the robot motion control method in this embodiment of the present disclosure.

For example, the processor 620 may be configured to execute the above robot motion control method according to an instruction in the computer program.

In some embodiments of the present disclosure, the processor 620 may include, but is not limited to:
a general-purpose processor, a digital signal processor (DSP), an application specific integrated circuit (ASIC), a field programmable gate array (FPGA), another programmable logic device, a discrete gate or transistor logic device, a discrete hardware component, or the like.

In some embodiments of the present disclosure, the memory 610 includes, but is not limited to:

Volatile memory and/or non-volatile memory. The non-volatile memory may be a read-only memory (ROM), a programmable read-only memory (programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which serves as an external cache. By way of example and not limitation, many forms of RAM are available, such as Static Random Access Memory (Static RAM, SRAM), Dynamic Random Access Memory (Dynamic RAM, DRAM), Synchronous Dynamic Random Access Memory (SDRAM), Double Data Rate SDRAM (DDR SDRAM), Enhanced SDRAM (ESDRAM), Synch link DRAM (SLDRAM), and Direct Rambus RAM (DR RAM).

In some embodiments of the present disclosure, the computer program may be divided into one or more modules, and the one or more modules are stored in the memory 610 and executed by the processor 620 to complete the robot motion control method provided in the present disclosure. The one or more modules may be a series of computer program instruction segments capable of completing a specific function, and the instruction segment is used to describe an execution process of the computer program in the robot.

As shown in FIG. 6, the robot 600 may further include: the transceiver 630 which may be connected to the processor 620 or the memory 610.

The processor 620 may control the transceiver 630 to communicate with another device, specifically, may send information or data to another device, or receive information or data sent by another device. The transceiver 630 may include a transmitter and a receiver. The transceiver 630 may further include an antenna, and there may be one or more antennas.

It should be understood that each component in the robot is connected to the bus system, where the bus system includes, in addition to a data bus, a power bus, a control bus, and a status signal bus.

The present disclosure further provides a computer storage medium having a computer program stored thereon, the computer program, when executed by a computer, causing the computer to perform the robot motion control method according to the foregoing method embodiments.

An embodiment of the present disclosure further provides a computer program product including a program instruction, where when the program instruction runs on an electronic device, the electronic device performs the robot motion control method in the foregoing method embodiments.

When implemented using software, it may be implemented in whole or in part in the form of a computer program product. The computer program product includes one or more computer instructions. When the computer program instructions are loaded and executed on a computer, the processes or functions according to embodiments of the present disclosure are all or partially generated. The computer may be a general purpose computer, a special purpose computer, a computer network, or other programmable device. The computer instructions may be stored in a computer-readable storage medium or transmitted from one computer-readable storage medium to another computer-readable storage medium, for example, the computer instructions may be transmitted from a website site, a computer, a server, or a data center to another website site, computer, server, or data center over a wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server or a data center integrated with one or more available media. The usable medium may be a magnetic medium (for example, a floppy disk, a hard disk, a magnetic tape), an optical medium (for example, a digital video disc (DVD)), a semiconductor medium (for example, a solid state disk (SSD)), or the like.

Those of ordinary skill in the art will appreciate that the modules and algorithm steps of the examples described in connection with embodiments disclosed herein can be implemented in electronic hardware, or in combination of computer software and electronic hardware. Whether these functions are performed in hardware or software depends on the specific application and design constraints of the technical solutions. Those skilled in the art may use different methods for each particular application to implement the described functionality, but such implementations should not be considered to be beyond the scope of the present disclosure.

In the several embodiments provided in the present disclosure, it should be understood that the disclosed systems, apparatuses, and methods may be implemented in other manners. For example, the apparatus embodiments described above are merely illustrative, for example, the division of the modules is merely a logical function division, and in actual implementation, there may be another division manner, for example, multiple modules or components may be combined or may be integrated into another system, or some features may be ignored, or not executed. Alternatively, the mutual coupling or direct coupling or communication connection shown or discussed may be an indirect coupling or communication connection through some interfaces, devices, or modules, and may be in electrical, mechanical, or other forms.

The modules described as separate components may or may not be physically separate, and the components displayed as modules may or may not be physical modules, that is, may be located in one place, or may be distributed to multiple network units. Some or all of the modules may be selected according to actual needs to achieve the purpose of the solution of this embodiment. For example, each functional module in embodiments of the present disclosure may be integrated into one processing module, or may be separately physically present by each module, or may be integrated in one module by two or more modules.

In this embodiment of the present disclosure, the terms “module” or “unit” refer to a computer program or a part of a computer program having a predetermined function, and work together with other relevant parts to achieve a predetermined target, and may be implemented in whole or in part by using software, hardware (for example, a processing circuit or a memory), or a combination thereof. Similarly, a processor (or multiple processors or memories) may be used to implement one or more modules or units. Further, each module or unit may be part of an overall module or unit containing the module or unit function.

The foregoing descriptions are only specific implementations of the present disclosure, but the protection scope of the present disclosure is not limited thereto, and any person skilled in the art may easily conceive of changes or replacements within the technical scope of the present disclosure, and should be covered within the protection scope of the present disclosure. Therefore, the protection scope of the present disclosure should be based on the protection scope of the claims.

I/We claim:

1. A motion control method of a robot, wherein the robot is a wheel-foot composite robot, the wheel-foot composite robot comprises a robot body and four motion mechanisms arranged on the robot body, the four motion mechanisms comprise two rear rollers and two front leg mechanisms, and the method comprises:
obtaining a to-be-performed task of the wheel-foot composite robot, wherein a motion mode of the wheel-foot composite robot is a wheel-foot composite motion mode;
determining a first motion task of the robot body, a second motion task of the two front leg mechanisms, and a third motion task of the two rear rollers based on the to-be-performed task; and
controlling whole-body motion of the wheel-foot composite robot based on the first motion task, the second motion task, and the third motion task.

2. The method of claim 1, wherein the controlling whole-body motion of the wheel-foot composite robot based on the first motion task, the second motion task and the third motion task comprises:
determining a target torque of each joint in each motion mechanism based on the first motion task, the second motion task, and the third motion task; and
controlling the whole-body motion of the wheel-foot composite robot based on the target torque of each joint in the each motion mechanism.

3. The method of claim 2, wherein the determining a target torque of each joint in each motion mechanism based on the first motion task, the second motion task, and the third motion task comprises:
editing the first motion task, the second motion task and the third motion task into a quadratic programming form, and solving by using a convex optimization algorithm to obtain the target torque of each joint in each motion mechanism.

4. The method of claim 2, wherein each joint in the each motion mechanism corresponds to one motor, and the controlling the whole-body motion of the wheel-foot composite robot based on the target torque of each joint in the each motion mechanism comprises:
controlling each motor to output the target torque to a corresponding joint based on the target torque of each joint, so as to implement whole-body motion control of the wheel-foot composite robot.

5. The method of claim 1, wherein the determining the first motion task of the robot body, the second motion task of the two front leg mechanisms, and the third motion task of the two rear rollers based on the to-be-performed task comprises:
determining a whole-body motion trajectory of the wheel-foot composite robot based on the to-be-performed task; and
determining the first motion task of the robot body, the second motion task of the two front leg mechanisms, and the third motion task of the two rear rollers based on the whole-body motion trajectory.

6. The method of claim 5, wherein
the first motion task is a motion task of a center point of the robot body;
the second motion task is a motion task of a lifted leg mechanism in the two front leg mechanisms;
the third motion task is a motion task of a center point of the two rear rollers.

7. The method of claim 6, wherein the whole-body motion trajectory comprises: a motion trajectory of the robot body, a motion trajectory of a lifted foot corresponding to the lifted leg mechanism, and a motion trajectory of the center point of the two rear rollers;
wherein the motion trajectory of the robot body comprises at least one expected position, at least one expected posture, at least one expected velocity, and at least one expected angular velocity;
the motion trajectory of the lifted foot corresponding to the lifted leg mechanism comprises at least one expected position and at least one expected velocity;
the motion trajectory of the center point of the two rear roller comprises at least one expected position, at least one expected posture, at least one expected velocity, and at least one expected angular velocity.

8. The method of claim 7, wherein the determining a first motion task of the robot body based on the whole-body motion trajectory comprises:
determining an actual position corresponding to each expected position, an actual velocity corresponding to each expected velocity, an actual posture corresponding to each expected posture, and an actual angular velocity corresponding to each expected angular velocity of the robot body;
determining a position motion sub-task of the robot body corresponding to each timestamp based on the expected position, the actual position, the expected velocity, and the actual velocity at a same timestamp; and
determining a posture motion sub-task of the robot body corresponding to each timestamp based on the expected posture, the actual posture, the expected angular velocity and the actual angular velocity at the same timestamp; and
obtaining the first motion task of the robot body corresponding to each timestamp based on the posture motion sub-task and the position motion sub-task of the robot body corresponding to each timestamp.

9. The method of claim 7, wherein the determining the second motion task of the lifted leg mechanism in the two front leg mechanisms based on the whole-body motion trajectory comprises:
determining an actual position corresponding to each expected position, and an actual velocity corresponding to each expected velocity of the lifted foot; and
determining the second motion task of the lifted leg mechanism in the two front leg mechanisms corresponding to each timestamp based on the expected position, the actual position, the expected velocity and the actual velocity at a same timestamp.

10. The method of claim 7, wherein the determining the third motion task of the center point of the two rear rollers based on the whole-body motion trajectory comprises:
determining an actual position corresponding to each expected position, an actual velocity corresponding to each expected velocity, an actual posture corresponding to each expected posture, and an actual angular velocity corresponding to each expected angular velocity of the center point of the two rear rollers;
determining, based on the expected position, the actual position, the expected velocity, and the actual velocity at a same timestamp, a position motion sub-task of the center point of the two rear rollers corresponding to each timestamp;
determining, based on the expected posture, the actual posture, the expected angular velocity and the actual angular velocity of the same timestamp, a posture motion sub-task of the center point of the two rear rollers corresponding to each timestamp;
obtaining the third motion task of the center point of the two rear rollers corresponding to each timestamp based on the posture motion sub-task and the position motion sub-task of the center point of the two rear rollers corresponding to each timestamp.

11. The method of claim 1, wherein the wheel-foot composite motion mode is obtained based on a wheel-type motion mode of the two rear rollers and a foot-type motion mode of the two front leg mechanisms.

12. A robot comprising:
a processor and a memory, where the memory is configured to store a computer program, and the processor is configured to invoke and run the computer program stored in the memory to perform:
obtaining a to-be-performed task of the wheel-foot composite robot, wherein a motion mode of the wheel-foot composite robot is a wheel-foot composite motion mode;
determining a first motion task of the robot body, a second motion task of the two front leg mechanisms, and a third motion task of the two rear rollers based on the to-be-performed task; and
controlling whole-body motion of the wheel-foot composite robot based on the first motion task, the second motion task, and the third motion task.

13. The robot of claim 12, wherein the controlling whole-body motion of the wheel-foot composite robot based on the first motion task, the second motion task and the third motion task comprises:
determining a target torque of each joint in each motion mechanism based on the first motion task, the second motion task, and the third motion task; and
controlling the whole-body motion of the wheel-foot composite robot based on the target torque of each joint in the each motion mechanism.

14. The robot of claim 13, wherein the determining a target torque of each joint in each motion mechanism based on the first motion task, the second motion task, and the third motion task comprises:
editing the first motion task, the second motion task and the third motion task into a quadratic programming form, and solving by using a convex optimization algorithm to obtain the target torque of each joint in each motion mechanism.

15. The robot of claim 13, wherein each joint in the each motion mechanism corresponds to one motor, and the controlling the whole-body motion of the wheel-foot composite robot based on the target torque of each joint in the each motion mechanism comprises:
controlling each motor to output the target torque to a corresponding joint based on the target torque of each joint, so as to implement whole-body motion control of the wheel-foot composite robot.

16. The robot of claim 12, wherein the determining the first motion task of the robot body, the second motion task of the two front leg mechanisms, and the third motion task of the two rear rollers based on the to-be-performed task comprises:
determining a whole-body motion trajectory of the wheel-foot composite robot based on the to-be-performed task; and
determining the first motion task of the robot body, the second motion task of the two front leg mechanisms, and the third motion task of the two rear rollers based on the whole-body motion trajectory.

17. The robot of claim 16, wherein
the first motion task is a motion task of a center point of the robot body;
the second motion task is a motion task of a lifted leg mechanism in the two front leg mechanisms;
the third motion task is a motion task of a center point of the two rear rollers.

18. The robot of claim 17, wherein the whole-body motion trajectory comprises: a motion trajectory of the robot body, a motion trajectory of a lifted foot corresponding to the lifted leg mechanism, and a motion trajectory of the center point of the two rear rollers;
wherein the motion trajectory of the robot body comprises at least one expected position, at least one expected posture, at least one expected velocity, and at least one expected angular velocity;
the motion trajectory of the lifted foot corresponding to the lifted leg mechanism comprises at least one expected position and at least one expected velocity;
the motion trajectory of the center point of the two rear roller comprises at least one expected position, at least one expected posture, at least one expected velocity, and at least one expected angular velocity.

19. The robot of claim 18, wherein the determining a first motion task of the robot body based on the whole-body motion trajectory comprises:
determining an actual position corresponding to each expected position, an actual velocity corresponding to each expected velocity, an actual posture corresponding to each expected posture, and an actual angular velocity corresponding to each expected angular velocity of the robot body;
determining a position motion sub-task of the robot body corresponding to each timestamp based on the expected position, the actual position, the expected velocity, and the actual velocity at a same timestamp; and
determining a posture motion sub-task of the robot body corresponding to each timestamp based on the expected posture, the actual posture, the expected angular velocity and the actual angular velocity at the same timestamp; and
obtaining the first motion task of the robot body corresponding to each timestamp based on the posture motion sub-task and the position motion sub-task of the robot body corresponding to each timestamp.

20. A non-transitory computer-readable storage medium configured to store a computer program, wherein the computer program causes a computer to perform:
obtaining a to-be-performed task of the wheel-foot composite robot, wherein a motion mode of the wheel-foot composite robot is a wheel-foot composite motion mode;
determining a first motion task of the robot body, a second motion task of the two front leg mechanisms, and a third motion task of the two rear rollers based on the to-be-performed task; and
controlling whole-body motion of the wheel-foot composite robot based on the first motion task, the second motion task, and the third motion task.
